(19) United States
(12) Patent Application Publication
(10) Pub. No.: US 2017/0337272 A1
(43) Pub. Date: Nov. 23, 2017

(54) Video Text - Strip Search

(71) Applicant: Gerard Currie, San Jose, CA (US)

(72) Inventor: Gerard Currie, San Jose, CA (US)

(21) Appl. No.: 15/161,200

(22) Filed: May 21, 2016

(51) Int. Cl. G06F 17/30; G11B 27/28

(52) U.S. Cl. CPC G06F 17/30796; G06F 17/30858; G11B 27/28

(57) ABSTRACT

Video search mechanism using text based accelerator strip is disclosed. It utilizes the text and timestamp information found in the closed caption and subtitle files to locate specific video content. Knowing a single word in a phrase will create the foundation of a meaningful search. No words are typed directly into the system. The text is arranged in alphabetical order and placed into buckets, which are quickly and easily searched, leaving the user to within 2 seconds of the desired content.

This document is arranged in three sections:

(A) A written description of the invention;

(B) The manner and process of making and using the invention (the enablement requirement)

(C) The best mode contemplated by the inventor of carrying out the invention.

(A) Video Text Strip Search Description

The invention is a software solution that utilizes the text and timestamp information found in the closed caption, subtitle or transcript files, used as companions to most educational video collections. This solution serves essentially the same purpose as an index at the back of a text book. Alphabetized phrases are used to locate, and launch specific video lessons to within 2 seconds of the desired content. The program's unique architecture (the distributed decigram) makes knowing a single word in a phrase the foundation of a meaningful search. No words are typed into the system. The alphabetized phrases are placed within 36 buckets, which are quickly and easily searched by dragging the mouse (or finger on a smart phone or tablet) over a strip. Clicking on the strip once the desired phrase has been located, creates a hyperlink, when followed launches the video to the precise location of where the phrase was spoken.

(note: this process is designed to be used in conjunction with conventional search systems, where topics, descriptions and meta data guide the student to a subset of video lessons. The Video Text Strip Search is designed to take the student the rest of the way by helping them locate specific frames within a particular lesson).

### DETAILED DESCRIPTION OF THE INVENTION

All spoken words held within a video collection are arranged in ten word phrases (which I call distributed decigrams). These phrases are constructed from sub-title, closed caption or transcript files that accompany each video, rather than indexing the video file itself. Each phrase consists of a single word (located at a specific timestamp), followed by the nine following words, and separated by spaces. These phrases are then arranged in alphabetical order and placed within 36 buckets (0-9 and a-z correspond to the keys on a keyboard). The first letter of each phrase corresponds to the name of the bucket. Clicking one of the thirty six keys allows the user to load the top accelerator search strip with the selected bucket, providing the first layer of filtering. Moving the mouse (or finger on a tablet) over the top strip presents each ten word phrase in alphabetical order. Scanning through the ten word phrases allows the user to read how the words are used in their proper context. Clicking the mouse (or finger) on the accelerator strip creates a link to the specific video content. When the link is followed the video is launched to within 2 seconds of the spoken content. A secondary accelerator strip is also provided to allow more refinement. It provides access to the ten decigram phrases preceding the current location (determined by the top accelerator) and nine decigrams following the current location. The user can also click the “Previous” and “Next” button to decrement/increment through each phrase of the decigram collection to further refine the search.

(note: sub title, close caption or transcript files must be present to create the index. The video files do not).

(B) Making a Video Text Strip Search
Overview (Detailed Description Follows)
   1. Read closed captioned, subtitle or video transcript file into an array and convert to lower case, remove all punctuation and special characters except the periods at the end of the sentence.
   2. Read through this array creating a secondary array of individual words transposing rows to a single column and assigning timestamps to each word. Timestamps are interpolated by divided the number of words between timestamps by the number of seconds between timestamps. These timestamps are rounded down to insure that the user is placed before the spoken segment as it is displayed in the video, rather than after.
   3. Create URL linking timestamps to specific locations within each indexed video lesson.
   4. Create a file topic. This topic corresponds to the name of each video being indexed. This topic will provide secondary confirmation for content relevancy.
   5. Create decigram phrase array. Populate the decigram field by appending the following nine words in the array to the current word (separated by a space). This will become the ten word phrase that the user interacts with on the accelerator strip.
   6. Attach each decigram to the timestamped URL.
   7. Sort on the decigram field and create the file names (using the first letter of the decigram) for each of the 36 output JavaScript files, along with their corresponding html templates. Each JavaScript file will contain 3 arrays of data pertaining to specific keys (0-9) and (a-z). These files are dynamically loaded into an iframe as the user interacts with the primary interface document.
   8. Create and populate the JavaScript files with three arrays: 1) the txtArray consisting of each decigram, 2) the urlArray consisting of each timestamped url, 3) the topicArray consisting of the URL associated with the single topic.
   9. Create the html templates to hold and interact with the javascript arrays.
   10. Create the primary user Interface html document. This html document consists of 36 buttons (0-9) and (a-z) keys, and an i-frame to present each template. The html template has 2 accelerator strips: a coarse accelerator (top) and a refine accelerator (bottom). A “Previous” and “Next” button enable the user to decrement/increment through each decigram in the array.

Making the Video Text Strip Search (Details)

I've created an excel workbook to show the data structure as it moves from raw input to the finished Video Text Strip Search documents. Screenshots are included to illustrate the objective (and outcome) at each step of the process. The input data source used is a transcript text file (similar to the transcripts found on Youtube) name vtsshelp.txt

1) Read closed captioned, subtitle or video transcript file into an array and convert to lower case and remove all punctuation and special characters (the period at the end of the sentence is the exception).

The screenshot (below) shows the original transcript file (vtsshelp.txt) in notepad as it was brought into Excel (this constitute the first data array).

2) Read through this array creating a secondary array of individual words transposing rows into a single column and assigning timestamps to each word. Timestamps are interpolated by divided the number of words between timestamps by the number of seconds between timestamps. These timestamps are rounded down to insure that the user is placed before the segment as it is displayed in the video, rather than after.

The screen below shows the original timestamps in column 1, the interpolated timestamps in column 2 and the transposed text in column 3.

3) Create URL linking timestamp to location within video. In this case, we're looking at a local file name vtsshelp.mp4. The suffix “#t=” represents start video at this timestamp (in seconds) and column E shows the URL address with the timestamp appended.

4) Create a file topic. This topic corresponds to each video being indexed (remember a collection of videos are being indexed so identification by topic is very important). This topic will provide secondary confirmation of content relevancy and become a hyperlink, when clicked, takes the user to the beginning of that particular video.

5) Create decigram phrase array. Populate the decigram field by appending the following nine words in the array to the current word (separated by a space). This will become the ten word phrase that the user interacts with on the accelerator strip.

6) Attach each decigram to the timestamp URL. These URLs will serve as the final link and will place the user to within 2 seconds of the desired video content.

7) Sort on the decigram field and create the file names (using the first letter of the decigram) for each of the 36 output JavaScript files, along with their corresponding html templates. Each JavaScript file will contain 3 arrays of data pertaining to specific keys (0-9) and (a-z). These files are dynamically loaded into an iframe as the user interacts with the primary interface document.

(note: some of the 36 keys may not be represented. In the example below there is no decigram that begins with the number “1”. In this case, the primary user interface will display a placeholder without the key value so that the user doesn't click on key having no data behind it).

8) Create and populate the Javascript files with three arrays: 1) the txtArray consisting of each decigram, 2) the urlArray consisting of each timestamped url, 3) the topicArray consisting of the URL associated with the single topic.

Shown below; is the contents of “v” javascript file. The arrays are populated in the decigram's chronological order.

9) Create the html templates to hold and interact with the javascript arrays. Shown below is the html document that will be presented in the iframe if the user clicked on the “v” key. Both strips are 600 pixels in length. A decigram phrase is mapped to each of the 600 pixels in the top strip. If there are more 600 decigrams, say 1200, then every other decigram is mapped and the secondary strip is utilized

10) Create the primary user Interface html document. This html document consists of 36 buttons (0-9) and (a-z) keys, and an i-frame to present each template. The html template has 2 accelerator strips: a coarse accelerator (top) and a refine accelerator (bottom). A “Previous” and “Next” button enable the user to decrement/increment through each decigram in the array.

Show below is the final product where the letter “v” was clicked and the mouse was moved over the top accelerator strip. The code (lower right) shows the “src” section of the iframe that changes when a user clicks on a different key.

(Note: a working example of the program can be seen at this URL: http://www.sharexl.comNTS/EastSide/EastSide.html)

Relationship Between The Components:

The program interacts directly with the 36 html and JavaScript data files corresponding to each key. The data file is selected when the user clicks on a key within the User Interface which constitutes the first round of filtering. This places the html template and JavaScript file corresponding to the selected key into the i-frame. The data found in the selected JavaScript file serves as a searchable dataset. Moving the mouse over the top “accelerator strip” presents a series of ten word phrases arranged in alphabetical order. The user clicks the top “accelerator strip” at the location of the desired text. A link appears, when clicked, launches the video to within 2 seconds of the spoken text. The selected record location and number of records are also displayed, along with the topic. After clicking on the top accelerator for close proximity in a large index, the user can refine the search by scrolling the lower accelerator strip to the desired location, or clicking the “Previous” or “Next” buttons. The record location within the array is used as reference to determine the bottom accelerator center point. Ten records preceding and nine following the center point are accessible through the bottom accelerator. The record location can also be decremented/incremented using the “Previous” and “Next” buttons respectively.

(C) The Best Mode Contemplated by the Inventor of Carrying Out His Invention

The Effective Use Of A Video Text Strip Search In An Educational Environment

I can see the Video Text Strip Search (VTSS) as a tool that greatly enhances the speed and effectiveness of video education. This product is designed to be a companion to any online video education solution where the student views between 20-30 online video lessons (approximately 8-10 minutes in length) and takes a series of periodic quizzes and exams that quantify knowledge transfer.

By establishing a “best practice” for lesson design, I see instructors specifically announcing objectives, sample #, figure # and summaries within their video lessons. Once the student understands the structure, answers to incorrect test questions will be located within seconds, rather than minutes.

But this is just the beginning. I can imagine this process significantly improving the quality of teaching. In all online courses there is an assumption that the material is well presented and only the students are scored. By matching missed test scores, and examining the student's click stream, the instructor can see where their message needs improving. Having this new level of granularity will enable the instructor to really focus on improving the message, utilizing the phrases each student used while to locate the correct answer.

1. A method of locating specific content within a video source using text phrases sharing similar content and timeline on a display, comprising:
Providing a memory which is able to create time stamps for each word in said timeline,
Providing a memory which is able to construct said phrases from said time stamped words in said timeline,
Providing a pointer means from which a human operator can manipulate to select any said phrase from said memory,
Providing a memory controller which will:
direct any selected phrase by the said pointer input means to the location of the said phrase of the said memory, beginning at the address of the said time stamp of the first word in the said phrase displayed on the said display, and
cause the said video source to be displayed on the said display, beginning at the address of the said time stamp of the first word in the said selected phrase displayed on the said display in said memory,
whereby said display will display said video content starting at the said time stamp of the first said word of the said pointed phrase in said memory.
